(19) United States
(12) Patent Application Publication
(10) Pub. No.: US 2025/0266640 A1
(43) Pub. Date: Aug. 21, 2025

(54) SEALED CONNECTOR WITH INTEGRAL SEAL FOR HOUSING AND TERMINAL ASSEMBLY

(71) Applicants: APTIV CONNECTION SYSTEMS (NANTONG) LTD., Nantong (CN); APTIV ELECTRICAL CENTERS (SHANGHAI) CO. LTD., Shanghai (CN)

(72) Inventors: Xiaoxian TIAN, Shanghai (CN); Yingquan JING, Shanghai (CN)

(21) Appl. No.: 19/057,040

(22) Filed: Feb. 19, 2025

(30) Foreign Application Priority Data
Feb. 20, 2024 (CN) 202410190448.8

(51) Int. Cl. H01R 13/52; H01R 13/506

(52) U.S. Cl. CPC H01R 13/5202; H01R 13/506

(57) ABSTRACT

A sealed connector includes a first housing with a first containing cavity and a second housing assembly comprising a second housing body and an integral seal. The integral seal features a first seal part for sealing between the first housing and the second housing body, and a second seal part positioned within the second containing cavity of the second housing body, which communicates with the first containing cavity. A terminal assembly is positioned within the first containing cavity, with at least a portion extending into the second containing cavity. The second seal part ensures sealing between the terminal assembly and the second housing body, providing a robust and dependable seal for the connector assembly.

### CROSS-REFERENCE TO RELATED APPLICATION

This application claims benefit of priority to Chinese Patent Application No. 202410190448.8 filed on Feb. 20, 2024, the entire disclosure of which is hereby incorporated by reference.

### TECHNICAL FIELD OF THE INVENTION

This application relates to the technical field of electric connector, and in particular, relates to a two-part form sealed connector.

### BACKGROUND

In the prior art, a small or miniaturized sealed electric connector usually relies on multiple seals to achieve sealing between multiple connected parts, so that the connector can obtain waterproof performance. However, due to the large number of seals and parts for retaining the seals (seal retainers), the assembly process of the connector is relatively cumbersome, and the assembly efficiency is low. Also, there is room for improvement in the waterproof effect of the sealed connector.

Sealed connectors have been widely used in various industries to ensure the integrity and reliability of electrical connections in environments exposed to moisture, dust, and other contaminants. Traditional approaches to sealed connectors often involve the use of separate sealing components, such as O-rings or gaskets, which are manually assembled between the connector housings. These separate sealing components can be prone to misalignment or damage during assembly, leading to potential sealing failures and increased manufacturing complexity.

Another approach has been the use of overmolded seals, where the seal is molded directly onto one of the connector housings. This method can improve the alignment and integrity of the seal, but it often requires additional manufacturing steps and specialized equipment, increasing production costs. Additionally, overmolded seals may not provide sufficient flexibility to accommodate variations in terminal assembly sizes or configurations, limiting their applicability in diverse applications.

Some designs have incorporated multi-part housings with integrated seals, where the seal is formed as part of the housing structure. While this can simplify assembly and improve sealing performance, it often results in increased material usage and complexity in the housing design. Furthermore, these designs may not adequately address the need for sealing both the interface between the housings and the terminal assembly within the connector, potentially compromising the overall effectiveness of the seal.

However, none of these approaches have provided a comprehensive solution that combines the features described in this disclosure.

### SUMMARY

This disclosure provides a sealed electric connector for solving the above listed problems.

According to one aspect of this disclosure, a sealed connector is provided. The sealed connector includes a first housing having a first containing cavity, a second housing assembly including a second housing body, and an integral seal. The integral seal includes a first seal part and a second seal part. The first seal part provides sealing between the first housing and the second housing body. The second housing body has a second containing cavity in communication with the first containing cavity. The second seal part is arranged in the second containing cavity. A terminal assembly may be arranged in the first containing cavity. At least part of the terminal assembly is arranged in the second containing cavity. The second seal part is configured to seal the terminal assembly and the second housing body.

In the above sealed connector, the integral seal may further include a seal connection part, the second housing body may have a communication port in communication with the second containing cavity, the seal connection part may be configured to penetrate through the communication port and connected with the first seal part and the second seal part respectively.

In the above sealed connector, the connector may be a right-angle connector.

In the above sealed connector, the first housing may have an assembly port in communication with the first containing cavity and the second housing assembly may be embedded in the assembly port.

In the above sealed connector, the first containing cavity may include a first subcavity and a second subcavity which are in communication with each other, and the second housing assembly may be arranged in the second subcavity. The terminal assembly may include a contacting part and a wiring part which are connected to each other. The contacting part may be arranged in the first subcavity. The wiring part may be arranged in the second subcavity and at least part of the wiring part may be arranged in the second holding cavity. The wiring part may be used for connecting a cable.

In the above sealed connector, the contacting part and the wiring part may extend in different directions.

In the above sealed connector, optionally, the terminal assembly may be provided with a sealing groove along the circumferential direction and the second seal part may be embedded in the sealing groove.

In the above sealed connector, one of the first housing and the second housing assembly may be provided with a latching slot while the other of the of the first housing and the second housing assembly includes a latch. The latch is configured to latch with the latching slot to connect the first housing and the second housing assembly.

In the above sealed connector, the first seal part may include a first base portion and a first lip portion. The first base portion may be connected to the second housing body. The first lip portion may be arranged around the first base portion along the circumference of the first base portion and the first lip portion may be configured to connect with the first housing.

In the above sealed connector, the second seal part may include a second base portion and a second lip portion. The second base portion may be connected to the second housing body. The second lip portion may be connected to the second base portion and the terminal assembly and the second first lip portion may be looped on the terminal assembly.

In the above sealed connector, the second housing body may be provided with a first limiting groove. A part of the wiring part of the terminal assembly may be embedded in the first limiting groove. The first limiting groove may be used to limit the position of the connecting part along the extension direction of the contacting part.

In the above sealed connector, the first housing may have a limiting surface. The limiting surface may be used to enclose the second subcavity. The wiring part may be connected with the limiting surface. The limiting surface may be used to limit the position of the wiring part along the extension direction of the contacting part

In the above sealed connector, the first housing may have a second limiting groove. The second limiting groove may be arranged on the limiting surface. A part of the wiring part may be embedded in the second limiting groove, which may be used to limit the position of the wiring part along the extension direction of the wiring part.

The technical benefits of this disclosure include: an integral seal including a first seal part and a second seal part is preassembled onto the second housing assembly, so as to reduce the number of seals, and reduce the total number of parts for making the connector. Also, by providing an integral seal, there is no need to adjust the positions of separate seals during an assembly operation.

### BRIEF DESCRIPTION OF THE DRAWINGS

In order to provide a clearer explanation of the embodiments of the present disclosure, a brief introduction will be given to the drawings to be used for depicting the embodiments. It is obvious that the drawings described below are only some embodiments of the present disclosure.

FIG. 1 is an exploded view of the electric connector according to some embodiments.

FIG. 2 is a cross-sectional view of the electric connector according to some embodiments.

FIG. 3 is a cross-sectional view of the first housing of the electric connector according to some embodiments.

FIG. 4 is an isometric view of the first housing of the electric connector according to some embodiments.

FIG. 5 is a cross-sectional view of a second housing assembly of the electric connector according to some embodiments.

FIG. 6 is an isometric view of the second housing assembly of the electric connector according to some embodiments.

FIG. 7 is an isometric view of the second housing assembly from another angle of the electric connector according to some embodiments.

FIG. 8 is a cross-sectional view of an integral seal including a first seal and a second seal of the electric connector according to some embodiments.

FIG. 9 is an isometric view of the integrated seal including the first seal part and the second seal part of the electric connector according to some embodiments.

FIG. 10 is a cross-sectional view of the second housing body of the electric connector according to some embodiments.

FIG. 11 is an isometric view of the second housing body of the electric connector according to some embodiments.

FIG. 12 is a cross-sectional view of the terminal assembly of the electric connector according to some embodiments.

FIG. 13 is an isometric view of the terminal assembly of the electric connector according to some embodiments.

### DETAILED DESCRIPTION

The embodiments of the disclosure will be clearly and completely described below in combination with the drawings in the embodiment of the disclosure. It is appreciated the described embodiments are only part of the embodiments of the disclosure, not all of them. Based on the embodiments in the disclosure, all other embodiments obtained by those skilled in the art without creative work fall within the scope of protection of the disclosure.

In the description of this disclosure, it should be noted that, unless otherwise specified and limited, the terms “connected” and “coupled” should be understood in a broad sense, for example, it can be fixed connection, removable connection, or integrated connection. It can be mechanical connection, electrical connection, or mutual communication. It can be connected directly or indirectly through an intermediate medium. It can be the connection within two components or the interaction between two components. For those skilled in the art, the specific meaning of the above terms in the disclosure can be understood according to the specific circumstances. In the description of this disclosure, “multiple” means two or more, unless otherwise specifically defined. In addition, the terms “first” and “second” are only used for descriptive purposes and cannot be understood as indicating or implying relative importance or implicitly indicating the number of indicated technical features. Thus, the features defined as “first” and “second” may explicitly or implicitly include one or more features.

The following disclosure provides many different embodiments or examples to implement different structures of the present disclosure. In order to simplify the disclosure of the present disclosure, the components and settings of specific examples are described below. Of course, they are merely examples and are not intended to limit the present disclosure.

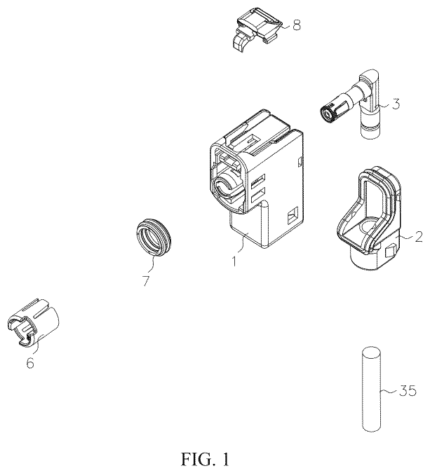

In order to solve the technical problems of cumbersome connector assembly process and low assembly efficiency, an embodiment of the disclosure provides an electric connector (also referred to as “connector”). Please refer to FIG. 1, which is an exploded schematic diagram of the connector provided by the embodiment of the disclosure. The connector includes a first housing 1, a second housing assembly 2, and a terminal assembly 3. The first housing 1 includes a first containing cavity 11, and the terminal assembly 3 is configured to be arranged in the first containing cavity 11. The second housing assembly 2 includes a second housing body 21. The second housing body 21 has a second containing cavity 213 in communication with the first containing cavity 11. The terminal assembly 3 is configured to be arranged in the first containing cavity 11, and at least part of the terminal assembly 3 is configured to be arranged in the second containing cavity 213. The second seal part 23 is configured to provide sealing connection between the connection terminal assembly 3 and the second housing body 21.

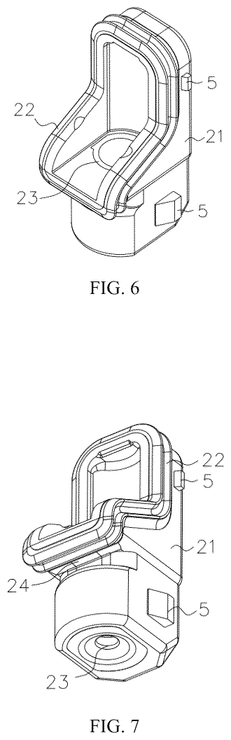

In some embodiments, the configuration of the second housing assembly 2 is shown in FIGS. 5, 6 and 7. The second housing assembly 2 is a preassembled component, and an integral seal 200 is preassembled on the second housing body 21 of the second housing assembly 2 in advance. The integral seal 200 includes a first seal part 22 for sealing and connecting the second housing body 21 and the first housing 1, and a second seal part 23 for sealing and connecting the second housing body 21 and the terminal assembly 3. This configuration eliminates the requirement of seal retainers of two seals, reducing the number of connector parts, facilitating the transportation of connector parts, and simplifying the connector assembly process at customer end. In addition, during the assembly process, there is no need for the assembly personnel to manually adjust the position of a seal between the first housing 1 and the second housing assembly 2, and the position of a seal between the second housing assembly 2 and the terminal assembly 3, thus assembly error is avoided. The finished connector after assembly has better sealing and water resistance performance.

The integral seal 200 of the second housing assembly 2 further includes a seal connection part 24. The second housing body 21 has a communication port 211 which is in communication with the second containing cavity 213. The seal connection part 24 is configured to pass through the communication port 211 and is connected with the first seal part 22 and the second seal part 23, respectively.

In the above embodiment, the seal connection part 24 connecting the first seal part 22 and the second seal part 23 enables the first seal part 22 and the second seal part 23 to mutually limit each other's position, avoiding the displacement of the first seal part 22 and the second seal part 23 when assembling the second housing assembly 2 and the first housing 1, ensuring that the first seal part 22 and the second seal part 23 do not displace after assembling the connector, resulting in better sealing effect. In addition, the seal connection part 24 which can limit the position of the first seal part 22 and the second seal part 23 can eliminate the requirement of seal retainer, further reducing the number of connector parts, facilitating the transportation of connector parts, and simplifying the assembly procedure of the connector by customers.

In some embodiments, the second housing body 21 further has a seal limiting surface, and the first seal part 22 is configured to be interfaced with the seal limiting surface. When the first housing 1 is configured to be connected with the second housing assembly 2 and the second housing body is moving towards the inside of the first containing cavity 11, the seal limiting surface can prevent the first seal part 22 from moving towards to the second housing body 21 under the action of friction. In addition, the interaction between the seal limiting surface and the seal connection part 24 can further reduce the relative movement between the first seal part 22 and the second seal part 23, so that the positions of the first seal part 22 and the second seal part 23 relative to the second housing body 21 are more stable and not prone to offset. Specifically, the second housing body 21 is provided with a step, which is configured to define the seal limiting surface, and the first seal part 22 is configured to be embedded in the step.

It can be understood that since the seal connection part 24 is an elastic part, the seal connection part 24 can prevent the first seal part 22 and the second seal part 23 from moving away from each other. The seal limiting surface can prevent the first seal part 22 from moving in a direction towards the second seal part 23. Therefore, the presence of both the sealing connection part 24 and the seal limiting surface can better secure the positions of the first seal part 22 and the second seal part 23, avoiding the offset of the first seal part 22 and the second seal part 23 during the assembling process, and making the finished connector have reliable water-proof sealing performance.

In the above embodiment, by providing the integral seal 200 consisting of the first seal part 22, the second seal part 23 and the seal connection part 24, the position limiting effect between the first seal part 22, the second seal part 23 and the seal connection part 24 can be better, the connection between the first seal part 22, the second seal part 23 and the second housing body 21, the first housing 1 is more tight, and the sealing and waterproof effect of the connector is better.

In addition, the integral structure can make the connection performance of the first seal part 22, the second seal part 23 and the seal connection part 24 better, as the seal connection part 24 is not prone to break with the first seal part 22 and the second seal part 23 under the condition of continuous force, so that the first seal part 22 and the second seal part 23 can still limit each other's position under the condition of continuous force, so that the connector can obtain the lasting sealing and waterproof performance, and the service life of the connector is longer and the reliability is better.

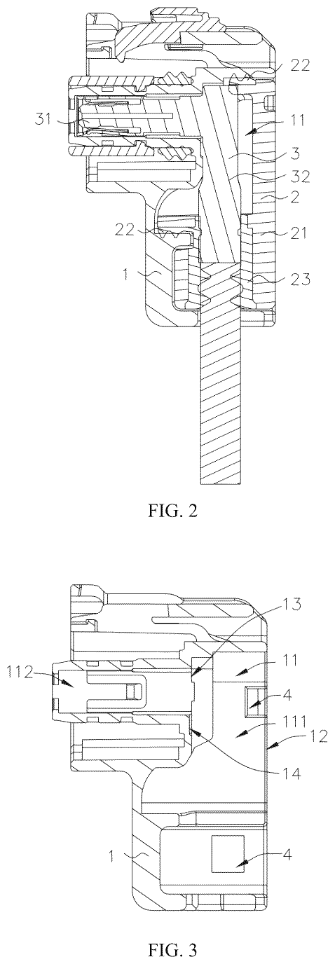

Some aspects of the embodiments are illustrated in FIGS. 2-4. The first housing 1 has an assembly port 12 in connection with the first containing cavity 11, and the second housing assembly 2 is configured to be embedded in the assembly port 12. Specifically, in the assembly process of the connector of the embodiment of the disclosure, the assembling of the connector can be completed by simply embedding the second housing assembly 2 into the first housing 1. At the same time, the sealing between the first housing 1 and the second housing assembly 2 is also completed. The assembly process is simple, the assembly efficiency is higher, and it is more suitable for mass assembly. The assembled connector has better sealing and waterproof performance and higher reliability.

In some embodiments, a terminal assembly as shown in FIGS. 2, 12, and 13 is provided. Taking reference to FIG. 3, the first containing cavity 11 of the first housing 1 includes a first subcavity 111 and a second subcavity 112 which are in communication with each other, and the second housing assembly 2 is configured to be arranged in the second subcavity 112. The terminal assembly 3 includes a contacting part 31 and a wiring part 32 which are connected together. The contacting part 31 is configured to be arranged in the first subcavity 111 of the first housing 1, the wiring part 32 is arranged in the second subcavity 112 of the first housing 1, and at least part of the connection part 32 is configured to be arranged in the second containing cavity 213 of the second housing assembly 2. The wiring part 32 is used to connect the harness. The contacting part 31 and the wiring part 32 of the terminal assembly 3 may be of an integral structure.

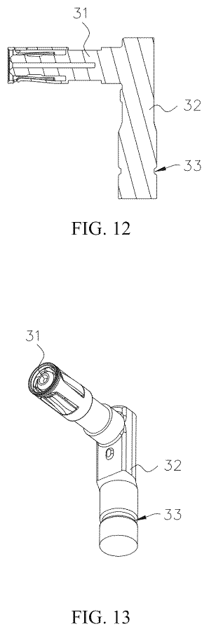

The contacting part 31 of the terminal assembly 3 can be either a male end or a female end (a female end is shown in FIGS. 12-13), and the corresponding terminal assembly 3 can be either a male terminal assembly 3 or a female terminal assembly 3, and the corresponding connector in this disclosure can be either a male or a female connector.

In some embodiments, the first housing 1 includes a sidewall to enclose the first subcavity 111. The connector also includes an anti-rotation component 6, which is configured to avoid rotation around the extension direction of the contacting part 31 between the two connectors after the illustrated connector is connected with another connector. In particular, the end of the anti-rotation component 6 is provided with an anti-rotation groove or anti-rotation protrusion, and the other connector mated with the connector is provided with an anti-rotation protrusion or anti-rotation groove corresponding to the anti-rotation groove or anti-rotation protrusion on the anti-rotation component 6 to realize the anti-rotation function.

In some embodiments, the connector further includes a front seal 7, which can be a sealing ring and is provided on the sidewall. The front seal 7 is used to provide inter-connector sealing when the illustrated connector is connected with another connector.

In some embodiments, the connector further includes a secondary locking component 8, which is configured to be connected to the first housing 1. The secondary locking component 8 is used to provide enhanced retention force when the illustrated connector is connected to another connector, so as to prevent the two connectors from moving opposite to each other along the extension direction of the contacting part 31.

Taking reference to FIGS. 2, 12, and 13, the contacting part 31 and wiring part 32 of the terminal assembly 3 extend in different directions. In some embodiments, the angle between the extension direction of the contacting part 31 and the extension direction of the wiring part 32 of the terminal assembly 3 is 90°. In other embodiments, the contacting part 31 and the wiring part 32 extend in the same direction.

In some embodiments, taking reference to FIGS. 2, 12, and 13, the terminal assembly 3 is provided with a sealing groove 33 along the circumferential direction, and the second seal part 23 is embedded in the sealing groove 33. In the above embodiment, when the terminal assembly 3 penetrates through the second seal part 23, due to the elastic deformation of the second seal part 23, a part of the second seal part 23 will be squeezed into the sealing groove 33, so that the sealing effect of the second seal part 23 is better. In addition, the part of the second seal part 23 squeezed into the sealing groove 33 can also limit the position of the terminal assembly 3, which can prevent the terminal assembly 3 from moving along the extension direction of the wiring part 32 and improve the connection stability of the connector.

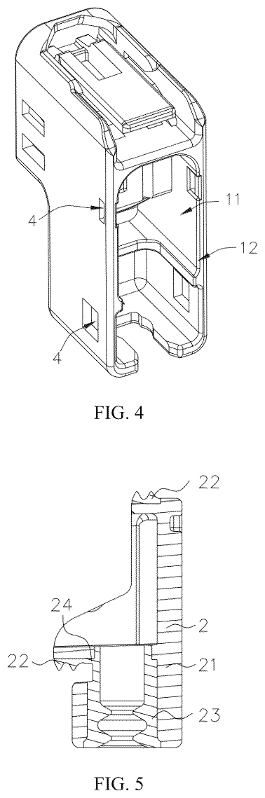

In some embodiments, one of the first housing 1 and the second housing assembly 2 is provided with a latching slot 4, and the other one has a latch 5. The latch 5 is clamped in the latching slot 4 to connect the first housing 1 and the second housing assembly 2. Refer to FIGS. 4, 6 and 7, in some embodiments, all latches 5 are provided in the second housing body 21 of the second housing assembly 2, and all latching slots 4 are provided in the first housing 1. In other embodiments, all the latching slots are provided in the second housing body 21, and all the latches 5 are provided in the first housing 1. In the above embodiment, the first housing 1 and the second housing assembly 2 are assembled together through the latches 5 and latching slots 4.

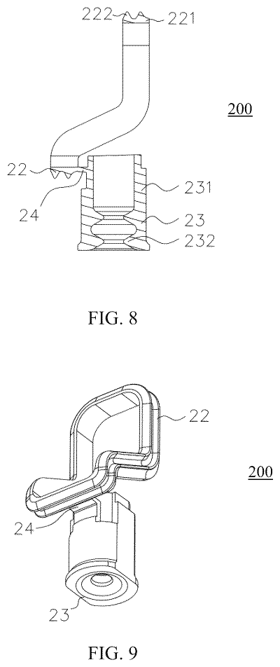

In some embodiments, taking reference to FIG. 8, the first seal part 22 includes a first base portion 221 and a first lip portion 222. The first base portion 221 is configured to be connected with the second housing body 21, and the first lip portion 222 is arranged around the first base portion 221 along the circumference of the first base portion 221, and the first lip portion 222 is configured to be connected with the first housing 1.

In the above embodiment, the first base portion 221 provided on the inner side is easier to be embedded in the first containing cavity 11 than the first lip portion 222 provided on the outer side. When the first base portion 221 enters the first containing cavity 11, the first lip portion 222 can also enter the first containing cavity 11 after elastic deformation. The first lip portion 222 entering the first housing cavity 11 has a larger size than the first base portion 221, and the first lip portion 222 has more elastic deformation than the first base portion 221. It can be understood that the first lip portions 222 can be a plurality, and the plurality of first lip portions 222 are spaced along the extension direction of the first base portion 221 at intervals.

In some embodiments, taking reference to FIG. 8, the second seal part 23 includes a second base portion 231 and a second lip portion 232. The second base portion 231 is configured to be connected to the second housing body 21, the second lip portion 232 is configured to be connected to the second base portion 231 and the terminal assembly 3, and the second lip portion 232 is provided around the terminal assembly 3.

In the above embodiment, the hole surrounded by the second base portion 231 on the outside is larger, and the hole surrounded by the second lip portion 232 on the inside is smaller. Compared with the second base portion 231, it is more difficult for the terminal assembly 3 to pass through the hole surrounded by the second lip portion 232. When the terminal assembly 3 extends into the hole surrounded by the second base portion 231, the second lip portion 232 produces elastic deformation, and the terminal assembly 3 can also extend into the hole surrounded by the second lip portion 232. The second lip portion 232 can produce greater elastic deformation than the second base portion 231, resulting in better sealing effect, so that the connector has better sealing connectivity between the second housing assembly 2 and the terminal assembly 3.

In some embodiments, the second lip portion 232 is configured to seal the wiring part 32. In other embodiments, the second lip portion 232 is configured to seal the cable 35 connected to the terminal assembly 3. In other embodiments, the second lip portion 232 is configured to seal both the wiring portion 32 and the cable 35 connected to the terminal assembly 3.

It can be understood that the second lip portions 232 can be a plurality, and the plurality of second lip portions 232 are spaced along the extension direction of the second base portions 231.

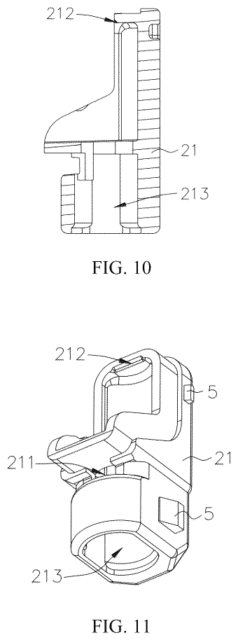

In some embodiments, referring to FIGS. 2, 10, and 11, the second housing body 21 has a first limiting slot 212, and a part of the wiring part 32 is embedded in the first limiting slot 212, and the first limiting slot 212 is used to limit the position of the wiring part 32 along the extension direction of the contacting part 31.

In the above embodiment, the wiring part 32 is configured to press against the second housing body 21 at the first limiting slot 212, and the first limiting slot 212 can limit the position of the wiring part 32 in the extension direction of the contacting part 31 and the extension direction of the wiring part 32, so as to avoid vibration of the terminal assembly 3 when the illustrated connector is mated with another connector, resulting in unstable signal transmission. Specifically, the first limiting slot 212 is provided at an inner edge of the second housing body 21. The first limiting slot 212 has a contact surface toward the first subcavity 111 and a contact surface toward the second containing cavity 213. The contact surface toward the first subcavity 111 is in contact with a part of the side of the wiring part 32 away from the first subcavity 111. The contact surface toward the first subcavity 111 can prevent the wiring part 32 from moving away from the first subcavity 111, so as to prevent the terminal assembly 3 from moving away from the first subcavity 111 when it is connected with a terminal assembly 3 of another connector under stress. The contact surface towards the second containing cavity 213 is in contact with the end face of the wiring part 32 away from the second containing cavity 213. The contact surface towards the second containing cavity 213 can prevent the wiring part 32 from moving away from the second containing cavity 213, so as to prevent the terminal assembly 3 from moving away from the second containing cavity 213 when it is connected with a terminal assembly of another connector under stress.

Alternatively, the first limiting slot 212 may only one contact surface, which is obliquely arranged near the end face and side face of the wiring part 32. The contact surface is butted with the edge at the intersection of the end face and side face, and the contact surface may also apply a force towards the first subcavity 111 and the second containing cavity 213 to the wiring part 32, so as to prevent the terminal assembly 3 from moving away from the first subcavity 111 or the second containing cavity 213 when it is connected with a terminal assembly of another connector.

In some embodiments, taking to FIGS. 2-4, the first housing 1 has a limiting surface 13, the limiting surface 13 is configured to enclose the second subcavity 112, the wiring part 32 is configured to be connected with the limiting surface 13, and the limiting surface 13 is configured to limit the wiring part 32 along the extension direction of the contacting part 31. The first subcavity 111 forms an opening on the limiting surface 13, from which the contacting part 31 extends into the first subcavity 111 from the second subcavity 112.

In the above embodiment, the limiting surface 13 presses against the wiring part 32, and the limiting surface 13 can limit the terminal in the extension direction of the contacting part 31. Specifically, the terminal assembly 3 is clamped between the first limiting slot 212 and the limiting surface 13 to prevent the terminal assembly 3 from moving along the extension direction of the contacting part 31, so as to avoid shaking of the terminal assembly 3 when the connector is inserted with another connector, resulting in unstable signal transmission.

In some embodiments, taking reference to FIG. 3, the first housing 1 has a second limiting slot 14, which is arranged on the limiting surface 13, and the part of the wiring part 32 is embedded in the second limiting slot 14 for limiting the wiring part 32 along the extension direction of the wiring part 32.

In the embodiments shown in FIGS. 1 to 13, the connector is described as a right-angle connector (that is, the insertion direction is perpendicular to the cable entrance direction). It should be understood that the scope of this disclosure is not limited to this.

Accordingly, other embodiments of the disclosure include a vehicle harness having the connector described above. Because the connector in the above embodiment has good sealing and waterproof performance, the vehicle harness with the connector has higher reliability under water conditions.

The above describes a connector and a vehicle harness provided by the embodiment of the disclosure. The disclosure has provided some specific examples to elaborate the principle and implementation mode of the disclosure. The description of the above embodiment is only used to help understand the technical scheme and its core idea of the disclosure. Those of ordinary skill in the art should understand that they can still modify the technical solutions recorded in the above embodiments or make equivalent replacement for some of the technical features. These modifications or substitutions do not make the essence of the corresponding technical solutions separate from the scope of the technical solutions of the embodiments of the disclosure.

### REFERENCE SIGNS

1 First Housing
11 First Containing Cavity
111 First Subcavity
112 Second Subcavity
12 Assembly Port
13 Limiting Surface
14 Second Limiting Slot
2 Second Housing Assembly
200 Integral Seal
21 Second Housing Body
211 Communication Port
212 First Limiting Slot
213 Second Containing Cavity
22 First Seal Part
221 First Base Portion
222 First Lip Portion
23 Second Seal Part
231 Second Base Portion
232 Second Lip Portion
24 Seal Connection Part
3 Terminal Assembly
31 Contacting Part
32 Wiring Part
33 Seal Groove
34 Limiting Protrusion
35 Cable
4 Latching Slot
5 Latch
6 Anti-Rotation Component
7 Front Seal
8 Secondary Locking Component

1. A sealed connector, comprising:
a first housing having a first containing cavity;
a second housing assembly comprising a second housing body and an integral seal, the integral seal includes a first seal part and a second seal part, the first seal part is configured to provide sealing between the first housing and the second housing body, and the second housing body has a second containing cavity in communication with the first containing cavity, and the second seal part is arranged in the second containing cavity; and
a terminal assembly to be arranged in the first containing cavity, and at least part of the terminal assembly is arranged in the second containing cavity, and the second seal part is configured to seal the terminal assembly and the second housing body.

2. The connector according to claim 1, wherein the integral seal further comprises a seal connection part and the second housing body has a communication port in communication with the second containing cavity.

3. The connector according to claim 1, wherein the seal connection part is configured to penetrate through the communication port and is connected with the first seal part and the second seal part, respectively.

4. The connector according to claim 1, wherein the connector is a right-angle connector.

5. The connector according to claim 1, wherein the first housing has an assembly port in communication with the first containing cavity, and the second housing assembly is embedded in the assembly port.

6. The connector according to claim 1, wherein the first containing cavity comprises a first subcavity and a second subcavity which are in communication with each other.

7. The connector according to claim 6, wherein the terminal assembly comprises a contacting part and a wiring part which are connected to each other.

8. The connector according to claim 6, wherein the contacting part is arranged in the first subcavity, the wiring part is arranged in the second subcavity, and at least part of the wiring part is arranged in the second containing cavity, and the wiring part is used for connecting a cable.

9. The connector according to claim 6, wherein the contacting part and the wiring part extend in different directions.

10. The connector according to claim 1, wherein the terminal assembly is provided with a sealing groove along a circumferential direction, and the second seal part is configured to be embedded in the sealing groove.

11. The connector according to claim 1, wherein one of the first housing and the second housing assembly is provided with a latching slot, and the other one comprises a latch, the latch is configured to latch with the latching slot to connect the first housing and the second housing assembly.

12. The connector according to claim 1, wherein the first seal part comprises a first base portion and a first lip portion and the first base portion is connected to the second housing body.

13. The connector according to claim 12, wherein the first lip portion is arranged around the first base portion along a circumference of the first base portion and the first lip portion is configured to connect with the first housing.

14. The connector according to claim 1, wherein the second seal part comprises a second base portion and a second lip portion and the second base portion is connected to the second housing body.

15. The connector according to claim 14, wherein the second lip portion is connected to the second base portion and the terminal assembly, and the second lip portion is looped on the terminal assembly.

16. The connector according to claim 6, wherein the second housing body is provided with a first limiting groove, wherein a part of the wiring part of the terminal assembly is embedded in the first limiting groove, and wherein the first limiting groove is used to limit a position of the connecting part along an extension direction of the contacting part.

17. The connector according to claim 6, wherein the first housing has a limiting surface, the limiting surface is used to enclose the second subcavity and the wiring part is connected with the limiting surface.

18. The connector according to claim 17, wherein the limiting surface is used to limit a position of the wiring part along an extension direction of the contacting part.

19. The connector according to claim 17, wherein the first housing has a second limiting groove, the second limiting groove is arranged on the limiting surface.

20. The connector according to claim 19, wherein a part of the wiring part is embedded in the second limiting groove, which is used to limit the position of the wiring part along the extension direction of the wiring part.
